(19) United States
(12) Patent Application Publication
(10) Pub. No.: US 2012/0320605 A1
(43) Pub. Date: Dec. 20, 2012

(54) LAMPSHADE FRAME ASSEMBLY

(76) Inventor: Wilson WU, Taipei City (TW)

(21) Appl. No.: 13/160,020

(22) Filed: Jun. 14, 2011

(51) Int. Cl. F21V 1/02

(52) U.S. Cl. 362/351

(57) ABSTRACT

An improved lampshade frame assembly comprising: a frame device, including an upper frame, a lower frame and a link rod seat coupled to the upper frame or the lower frame; a hood device, including a hood, a connecting strip with appropriate elasticity and separately formed at upper and lower positions of an internal side of the hood, and an external side of the connecting strip being fixed to the hood, and a pair of embedding grooves formed on an internal side of the connecting strip for coupling the upper frame and the lower frame respectively to achieve the effects of reducing the material and weight of a lamp and the packaging volume of the lampshade frame, saving the transportation cost, providing a secured assembly of the hood and frame, improving the quality, and enhancing the add-on value of the lamp.

### BACKGROUND OF THE INVENTION

1. Field of the Invention The present invention relates to a lampshade structure of a lamp, particularly to an improved lampshade frame assembly with convenient and secured assembly, and cost-effective and high-quality features.

2. Brief Description of the Related Art

Lamp is a common electric appliance used at home to provide necessary illuminations, create different atmospheres, and plays an important role in the interior design of modern homes. Various lamps such as ceiling lamps, floor lamps, wall lamps and table lamps are provided for different applications, and a lamp with a lampshade is usually used for creating indoor atmospheres. The lampshade can soften the light and adjust the brightness and color of the light.

Conventional lampshades for a lamp are mainly divided into fixed lampshades and removable lampshades. However, the fixed lampshade has a large packaging volume which is unfavorable for transportation and storage, and incurs a higher cost or easier damage during the transportation process. Therefore, the removable lampshades are introduced to the market. For example, the removable lampshade as disclosed in R.O.C. Pat. No. M350672 provides a simple and easy way of installing and removing a lampshade frame and a hood connected by Velcro tapes, such that the lampshade frame and the hood can be packaged separately, and such removable lampshade can save packaging and transportation costs. Although such conventional lampshade structure can be assembled and disassembled functions, it still has the following drawbacks. For example, the upper frame and the lower frame are attached by the Velcro tapes, and they must have sufficient area for the tapes, so that that the upper frame and the lower frame will come with a larger volume and a heavier weight and result in a higher material cost. Furthermore, the lampshade assembled by the Velcro tapes gives a poor appearance. Obviously, the conventional lampshade frame structure requires improvement, and it is a main subject for related manufacturers and designers to provide an improved lampshade frame structure to overcome the aforementioned manufacturing and using drawbacks.

In view of the shortcomings and the weak structural design of the conventional the lampshade structure, the inventor of the present invention developed an improved lampshade frame assembly with the effects of saving the material, reducing the weight, and improving the quality of the lampshade frame.

### SUMMARY OF THE INVENTION

In view of the foregoing drawbacks of the prior art, the inventor of the present invention based on years of experience in the related industry to conduct extensive researches and experiments, and finally developed an improved front removable expansion card module structure in accordance with the present invention to overcome the drawbacks of the present invention.

Therefore, it is a primary objective of the present invention to provide an improved lampshade frame assembly to achieve the effects of reducing the material and weight of a lamp and the packaging volume of the lampshade frame, and saving the transportation cost.

Another objective of the present invention is to provide an improved lampshade frame assembly to provide a secured assembly of the hood and frame, improve the quality, and enhance the add-on value of the lamp.

To achieve the aforementioned objectives, the present invention provides a technical measure and an improved lampshade frame assembly comprising: a frame device, including an upper frame, a lower frame and a link rod seat coupled to the upper frame or the lower frame; a hood device, having a hood, a connecting strip formed separately at upper and lower positions of an internal side of the hood, and an external side of the connecting strip being fixed to the hood, and a pair of embedding grooves formed on an internal side of the connecting strip for coupling the upper frame and the lower frame respectively.

The technical characteristics and effects of the present invention will become apparent by the detailed description of the preferred embodiments together with the illustration of related drawings as follows:

### BRIEF DESCRIPTION OF THE INVENTION

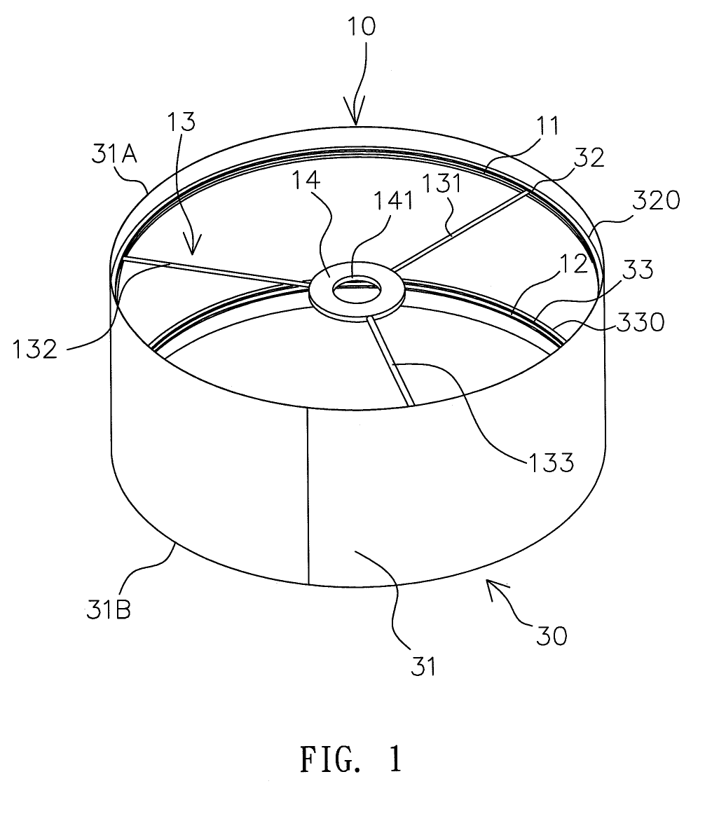

FIG. 1 is a perspective view of the present invention;

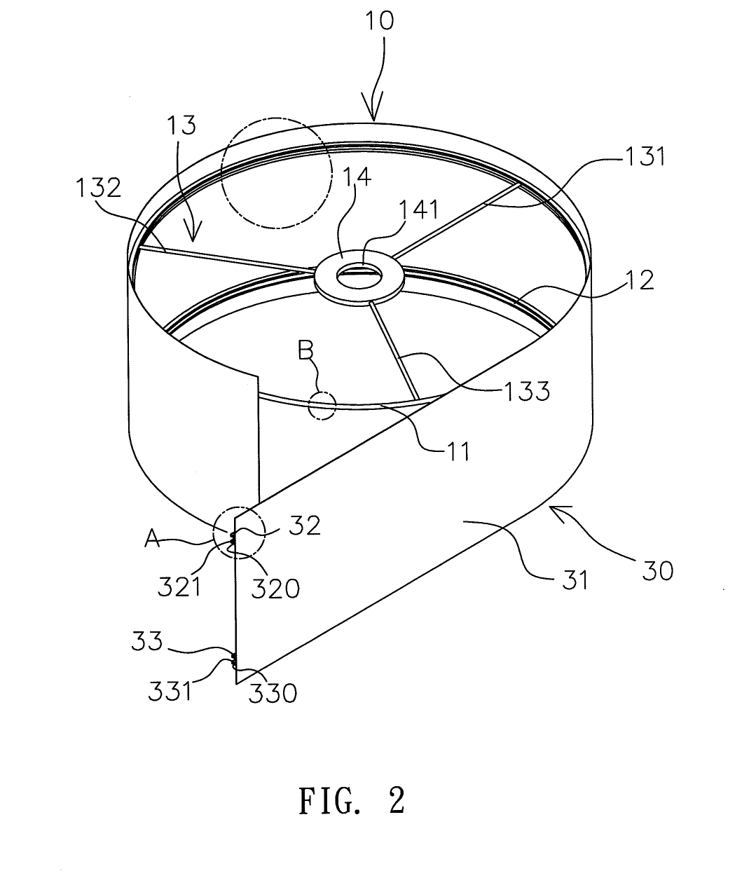

FIG. 2 is a partial perspective view of the present invention;

FIG. 2a is a close-up view of FIG. 2;

FIG. 2b is another close-up view of FIG. 2;

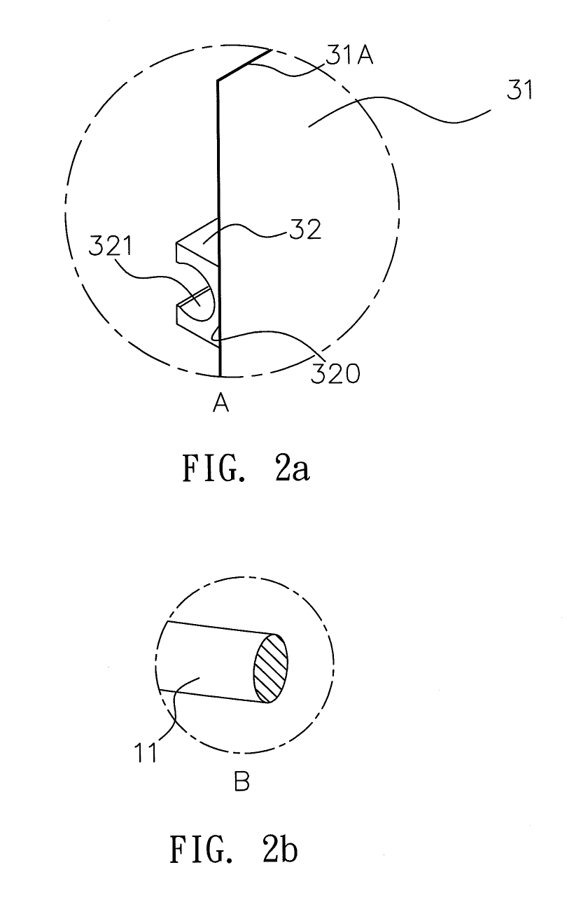

FIG. 3 is partial cross-sectional view of the present invention;

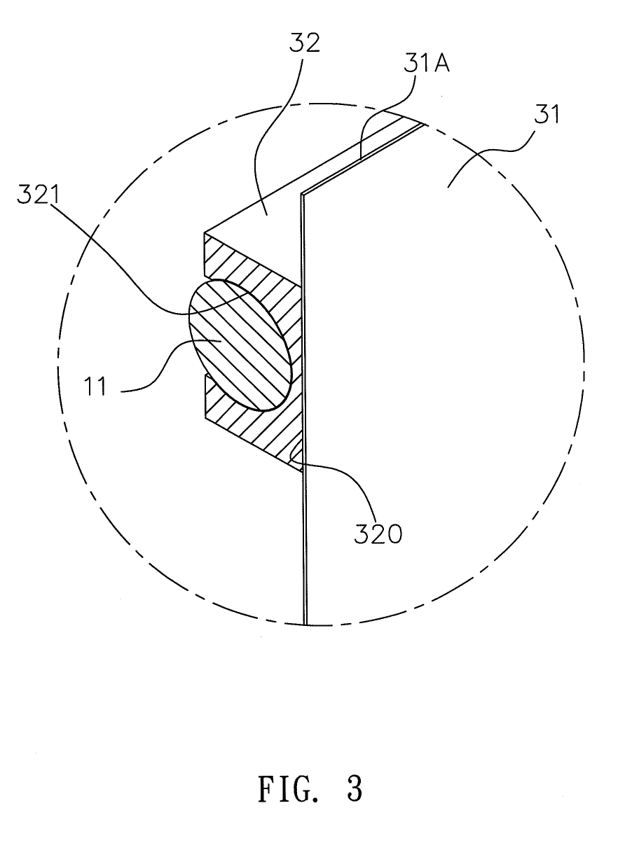

FIG. 4 is a schematic view of a connecting strip in accordance with a second preferred embodiment of the present invention; and

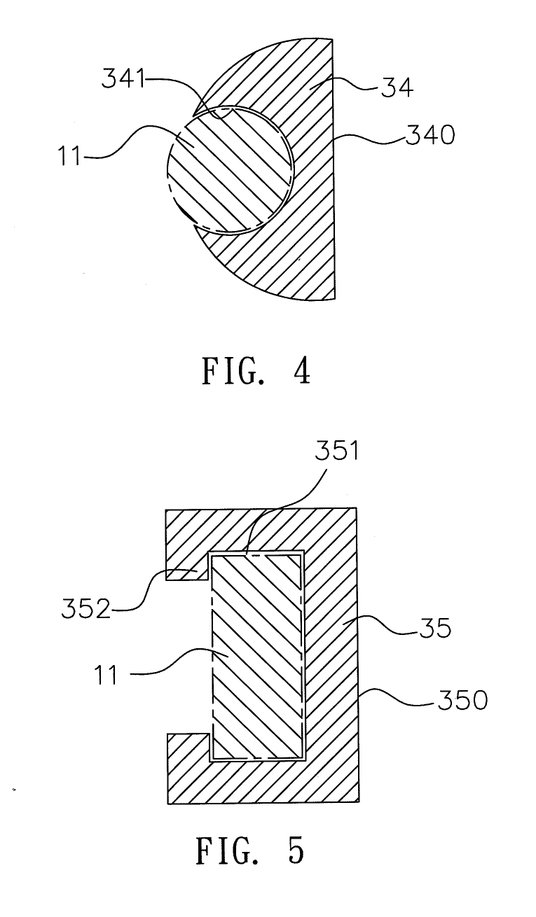

FIG. 5 is a schematic view of a connecting strip in accordance with a third preferred embodiment of the present invention.

### DETAILED DESCRIPTION OF THE PREFERRED EMBODIMENTS

With reference to FIGS. 1 to 3 for an improved lampshade frame assembly of the present invention, the lampshade frame assembly comprises a frame device 10 and a hood device 30. The frame device 10 comprises an upper frame 11, a lower frame 12 and a link rod seat 13. In this preferred embodiment, the upper frame 11 and the lower frame 12 are circular flexible rod bodies made of metal or another hard material, and the link rod seat 13 is coupled to the upper frame 11. In other embodiments, the link rod seat 13 can be coupled to the lower frame 12, and the link rod seat 13 includes three link rods 131, 132, 133, and an external end of each link rod 131, 132, 133 is coupled to the upper frame 11, and an internal end of each link rod 131, 132, 133 is coupled to a lampshade holder 14, and a through hole 141 is formed at the center of the lampshade holder 14.

The hood device 30 comprises a hood 31, a connecting strip 32, 33 separately formed at upper and lower positions of the internal side of the hood 31, wherein the connecting strips 32, 33 can be made of rubber or plastic to provide an appropriate elasticity of the connecting strips 32, 33, and each connecting strip 32, 33 has a connecting surface 320, 330 fixed to the internal side of the hood 31, and each connecting strip 32, 33 has an embedding groove 321, 331 formed at a corresponding position opposite to a surface of the upper frame 11 and the lower frame 12 (which is opposite to another surface of the connecting surface 320, 330). In addition, when the hood 31 is coupled to the connecting strip 32, 33, a top portion 31A of the hood 31 is arranged slightly higher than the connecting strip 32 and protruded upwardly with a certain distance beyond the connecting strip 32. Similarly, a bottom portion 31B of the hood 31 is arranged slightly lower than the connecting strip 33 and protruded downwardly with a certain distance beyond the connecting strip 33. When the improved lampshade frame assembly of the present invention is assembled, the upper frame 11 and the lower frame 12 are embedded into the embedding grooves 321, 331 of the connecting strips 32, 33 respectively for fixing the hood 31 to the upper frame 11 and the lower frame 12.

With reference to FIG. 4 for a connecting strip in accordance with the second preferred embodiment of the present invention, the structure of this embodiment is based on the structure of the first preferred embodiment, wherein the connecting strip 34 is designed with an arc-shaped body (or a hemispherical body) on one side, and the connecting strip 34 has a connecting surface 340 situated on the external side of the connecting strip 34 and an arc-shaped embedding groove 341 formed on the internal side of the connecting for embedding the circular rod shaped upper frame 11 and lower frame 12.

With reference to FIG. 5 for a connecting strip in accordance with the third preferred embodiment of the present invention, the structure of this embodiment is based on the structure of the first preferred embodiment, wherein the connecting strip 34 is designed with a cubic body (or a rectangular body) on one side, and the connecting strip 35 has a connecting surface 350 situated at the external side of the connecting strip 35, a square embedding groove 351 formed on the internal side of the connecting strip 35, and a stop portion 352 formed at a distal side of the square embedding groove 351, and the square embedding groove 351 is provided for embedding the square rod shaped upper frame 11 (or lower frame 12) into square embedding groove 351 and blocked by the stop portion 352 to prevent the square rod shaped upper frame 11 (or lower frame 12) from falling out. Therefore, the connecting surface at the external side of the connecting strip is preferably a flat surface, and the internal side of the connecting strip is substantially designed with a cubic body, rectangular body, arc-shaped body, hemispherical body or another appropriate shaped body, and the embedding groove can be a square, arc-shaped or another shaped embedding groove, and the upper frame and the lower frame are installed at position corresponding to the embedding grooves respectively.

With the aforementioned assembly, the improved lampshade frame assembly of the present invention achieves the effects of reducing the material and weight of the lamp and the packaging volume of the lampshade frame, saving the transportation cost, providing a secured assembly of the hood and frame, improving the quality, and enhancing the add-on value of the lamp.

In summation of the description above, the present invention complies with the patent application requirements, and is thus duly filed for patent application. While the invention has been described with reference to a preferred embodiment thereof, it is to be understood that modifications or variations may be easily made without departing from the spirit of this invention, which is defined in the appended claims.

What is claimed is:

1. An improved lampshade frame assembly, comprising:
a frame device, including an upper frame, a lower frame and a link rod seat coupled to the upper frame or the lower frame;
a hood device, including a hood, a connecting strip with appropriate elasticity and separately formed at upper and lower positions of an internal side of the hood, and an external side of the connecting strip being fixed to the hood, and a pair of embedding grooves formed on an internal side of the connecting strip for coupling the upper frame and the lower frame respectively.

2. The improved lampshade frame assembly of claim 1, wherein the upper frame and the lower frame are made of metal or a hard material.

3. The improved lampshade frame assembly of claim 1, wherein the link rod seat includes a plurality of link rods, and an external end of each link rod is coupled to the upper frame or the lower frame, and an internal end of each link rod is coupled to a lampshade holder, and a through hole is formed at the center of the lampshade holder.

4. The improved lampshade frame assembly of claim 1, wherein the connecting strip is made of rubber or plastic.

5. The improved lampshade frame assembly of claim 1, wherein the connecting strip has a connecting surface on the external side of the connecting strip for fixing the hood.

6. The improved lampshade frame assembly of claim 1, wherein the connecting strip has an internal side substantially a cubic body, a rectangular body, an arc-shaped body, a hemispherical body or another shaped body.

7. The improved lampshade frame assembly of claim 1, wherein the embedding groove is a square, arc-shaped or another shaped embedding groove.

8. The improved lampshade frame assembly of claim 1, wherein the upper frame and the lower frame are installed at positions corresponding to the embedding grooves respectively.

9. The improved lampshade frame assembly of claim 1, wherein each embedding groove has a stop portion at a distal side of the embedding groove.
